(19) United States
(12) Patent Application Publication
(10) Pub. No.: US 2023/0020147 A1
(43) Pub. Date: Jan. 19, 2023

(54) PEER-TO-PEER TERMINAL AND CONTRACT TRANSACTION SYSTEM

(71) Applicants: Mitsubishi Electric Corporation, Tokyo (JP); Tokyo Institute of Technology, Tokyo (JP)

(72) Inventors: Yuta OKUMURA, Tokyo (JP); Takuya ODA, Tokyo (JP); Yuya KAJIKAWA, Tokyo (JP); Keisuke TANAKA, Tokyo (JP); Xavier DEFAGO, Tokyo (JP)

(73) Assignees: Mitsubishi Electric Corporation, Tokyo (JP); Tokyo Institute of Technology, Tokyo (JP)

(21) Appl. No.: 17/782,665

(22) PCT Filed: Jan. 30, 2020
(86) PCT No.: PCT/JP2020/003410

§ 371 Date: Jun. 6, 2022

(51) Int. Cl. G06Q 20/22; G06Q 20/38; G06Q 40/04

(52) U.S. Cl. CPC G06Q 20/223; G06Q 20/389; G06Q 20/38215; G06Q 40/04

(57) ABSTRACT

A peer-to-peer terminal includes a bid data obtaining unit, a bid data transmitter, a contract result calculator, a contract result transmitter, a contract result receiver, and a contract result selector. The bid data obtaining unit obtains bid data. The bid data transmitter transmits the bid data to another peer-to-peer terminal. The contract result calculator calculates a contract result from a bid data set obtained by the bid data obtaining unit and including the bid data. The contract result transmitter transmits the contract result to the other peer-to-peer terminal. The contract result receiver receives, from the other peer-to-peer terminal, another contract result calculated by the other peer-to-peer terminal. The contract result selector selects one contract result from among the contract result and the other contract result.

### TECHNICAL FIELD

The present disclosure relates to a peer-to-peer terminal and a contract transaction system.

### BACKGROUND ART

Contract transaction systems each of which matches, through a network, a person who wishes to sell content with a person who wishes to purchase the content and completes a contract transaction have been proposed.

For example, in the financial asset transaction system described in Patent Document 1, a user who wishes to transact a financial asset operates a client terminal device (paragraph 0012). Furthermore, an exchange server device receives transaction information transmitted from each client terminal device through a network, and performs a process of orchestrating transactions based on the received pieces of transaction information (paragraph 0013).

### PRIOR ART DOCUMENT

### Patent Document

Patent Document 1: Japanese Utility Model Registration No. 3219516

### SUMMARY

### Problem to be Solved by the Invention

The conventional contract transaction systems typified by the financial asset transaction system described in Patent Document 1 adopt the client-server model. Here, a server performs a process of completing a contract transaction. Thus, the server is a single point of failure. When the server fails, the contract transaction system cannot be maintained. Prevention of an unauthorized access to the server and malware infection requires increasing the security strength of the server. This involves a cost for increasing the security strength of the server.

In contrast, in a peer-to-peer (P2P) network using, for example, blockchains, peer terminals communicate with each other. Unlike the server, the P2P network does not have a single point of failure. However, the P2P network has no terminal that manages the entire terminals unlike the server. When each of terminals in the P2P network performs a process of completing a contract transaction, a plurality of contract results calculated by the terminals are sometimes inconsistent. Thus, one reliable contract result is not identifiable.

The present disclosure has been conceived in view of these problems. The object of the present disclosure is to provide a contract transaction system that has no single point of failure and can identify one reliable contract result from among a plurality of inconsistent contract results.

### Means to Solve the Problem

The present disclosure relates to a peer-to-peer terminal.

The peer-to-peer terminal includes a bid data obtaining unit, a bid data transmitter, a contract result calculator, a contract result transmitter, a contract result receiver, and a contract result selector.

The bid data obtaining unit obtains bid data.

The bid data transmitter transmits the bid data to another peer-to-peer terminal.

The contract result calculator calculates a contract result from a bid data set obtained by the bid data obtaining unit, the bid data set including the bid data.

The contract result transmitter transmits the contract result to the other peer-to-peer terminal.

The contract result receiver receives, from the other peer-to-peer terminal, another contract result calculated by the other peer-to-peer terminal.

The contract result selector selects one contract result from among the contract result and the other contract result.

The present disclosure is also directed to a contract transaction system including the peer-to-peer terminals.

### Effects of the Invention

The present disclosure enables a peer-to-peer network including a plurality of peer-to-peer terminals to complete a contract transaction. This can provide a contract transaction system having no single point of failure. This can also provide a contract transaction system that can identify one reliable contract result from a plurality of inconsistent contract results.

The object, features, aspects, and advantages of the present disclosure will become more apparent from the following detailed description and the accompanying drawings.

### BRIEF DESCRIPTION OF DRAWINGS

FIG. 1 is a block diagram schematically illustrating a contract transaction system according to Embodiment 1.

FIG. 2 is a network diagram schematically illustrating a peer-to-peer (P2P) network configured by a plurality of terminals included in the contract transaction system according to Embodiment 1.

FIG. 3 is a block diagram schematically illustrating a hardware configuration of each terminal included in the contract transaction system according to Embodiment 1.

FIG. 4 is a flowchart illustrating a procedure to be performed by each terminal included in the contract transaction system according to Embodiment 1.

FIG. 5 illustrates example bid data to be obtained by each terminal included in the contract transaction system according to Embodiment 1.

FIG. 6 illustrates example contract results calculated by terminals included in the contract transaction system according to Embodiment 1.

FIG. 7 illustrates an example selection criterion to be referred to by each terminal included in the contract transaction system according to Embodiment 1.

FIG. 8 illustrates example blocks to be stored by each terminal included in the contract transaction system according to Embodiment 1.

FIG. 9 is a block diagram schematically illustrating a contract transaction system according to Embodiment 2.

FIG. 10 is a flowchart illustrating a procedure to be performed by each terminal included in the contract transaction system according to Embodiment 2.

FIG. 11 illustrates an example incentive percentage to be referred to by each terminal included in the contract transaction system according to Embodiment 2.

FIG. 12 illustrates an example incentive to be calculated by each terminal included in the contract transaction system according to Embodiment 2.

FIG. 13 schematically illustrates an example topology of the P2P network.

FIG. 14 is a block diagram schematically illustrating a contract transaction system according to Embodiment 3.

FIG. 15 is a flowchart illustrating a procedure to be performed by each terminal included in the contract transaction system according to Embodiment 3.

FIG. 16 illustrates an example evaluation criterion to be referred to by each terminal included in the contract transaction system according to Embodiment 3.

### DESCRIPTION OF EMBODIMENTS

### 1. Embodiment 1

### 1.1 Outline of Contract Transaction System

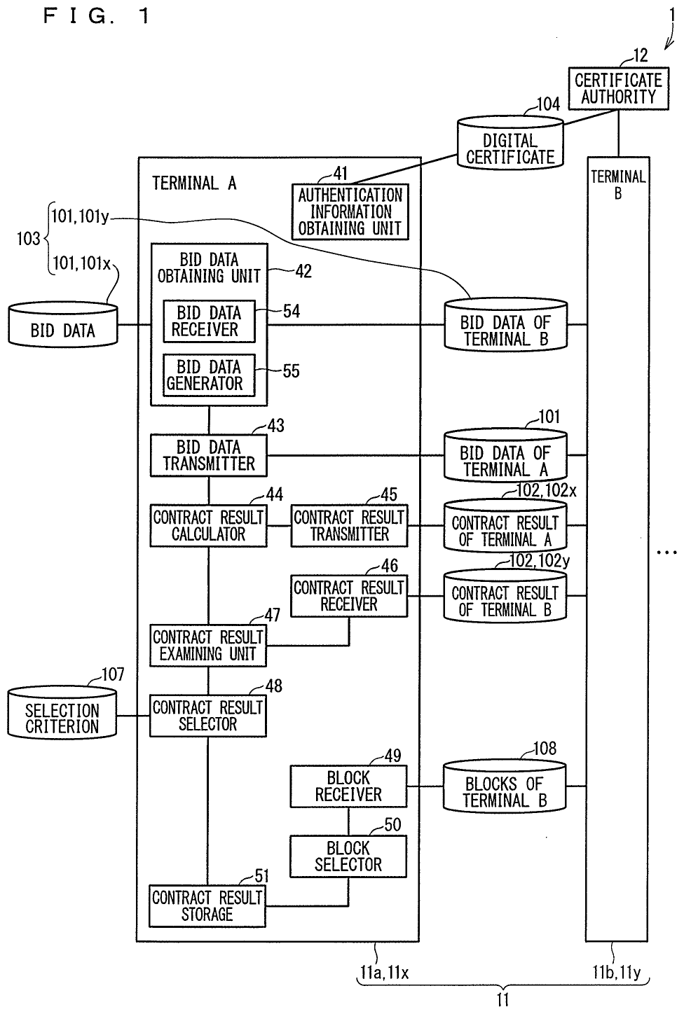

FIG. 1 is a block diagram schematically illustrating a contract transaction system according to Embodiment 1.

A contract transaction system 1 in FIG. 1 obtains bid data 101 created by the user. The obtained bid data 101 describes details of a bid for showing an intention of trading a product. The obtained bid data 101 is purchasing bid data or selling bid data. The purchasing bid data describes details of a purchasing bid for showing an intention of purchasing a product. The selling bid data describes details of a selling bid for showing an intention of selling a product. Examples of the product include securities, electric power, wheat, and gold.

The contract transaction system 1 completes a contract transaction between a purchasing bid and a selling bid, and calculates a contract result 102 indicating a result of the completed contract transaction. The contract transaction system 1 completes a contract transaction so that a purchasing user who has created the purchasing bid data can purchase a product at a price lower than or equal to the bidding price indicated by the purchasing bid data and that a selling user who has created the selling bid data can sell the product at a price higher than or equal to the bidding price indicated by the selling bid data.

A closing time for the bid is set in the contract transaction system 1. The contract transaction system 1 completes a contract transaction between a purchasing bid with details indicated by the purchasing bid data obtained until the set closing time for the bid and a selling bid with details indicated by the selling bid data obtained until the set closing time for the bid. The contract transaction system 1 completes a contract transaction at the set closing time for the bid. The closing time for the bid is set, for example, at regular intervals. The regular intervals are, for example, intervals of 5 minutes. When the regular intervals are intervals of 5 minutes, for example, TT:00, TT:05, TT:10, TT:15, TT:20, TT:25, TT:30, TT:35, TT:40, TT:45, TT:50, and TT:55 are set as closing times for the bid, where TT denotes an arbitrate hour.

1.2 Elements Included in Contract Transaction System

As illustrated in FIG. 1, the contract transaction system 1 includes a plurality of terminals 11, and a Certificate Authority 12. FIG. 1 illustrates only terminals 11a and 11b among the plurality of terminals 11.

In FIG. 1, the terminal 11a is handled as each terminal 11x included in the plurality of terminals 11, whereas the terminals 11b are handled as other terminals 11y included in the plurality of terminals 11 for convenience.

Each of the terminals 11x is a peer-to-peer (P2P) terminal configuring a P2P network.

Each of the terminals 11x obtains the bid data 101. The bid data 101 to be obtained is bid data 101x received by each of the terminals 11x from a terminal that is not included in the plurality of terminals 11, bid data 101y received by each of the terminals 11x from the other terminals 11y included in the plurality of terminals 11, or bid data that is generated by each of the terminals 11x and is not illustrated. Accordingly, each of the terminals 11x obtains a bid data set 103.

Each of the terminals 11x transmits the obtained bid data 101 to the other terminals 11y.

Each of the terminals 11x completes a contract transaction between a purchasing bid and a selling bid, and calculates a contract result 102x indicating a result of the completed contract transaction.

When a plurality of the bid data sets 103 obtained by the plurality of terminals 11 are consistent, a plurality of the contract results 102x calculated by the plurality of terminals 11 are also consistent. However, when the plurality of the bid data sets 103 are inconsistent because of a communication delay or an influence such as the topology of the P2P network configured by the plurality of terminals 11, the plurality of contract results 102x are sometimes inconsistent. When the plurality of contract results 102x are inconsistent, each of the terminals 11x selects one reliable contract result from among the plurality of contract results 102x.

The Certificate Authority 12 issues a digital certificate 104 of each of the terminals 11x.

1.3 P2P Network

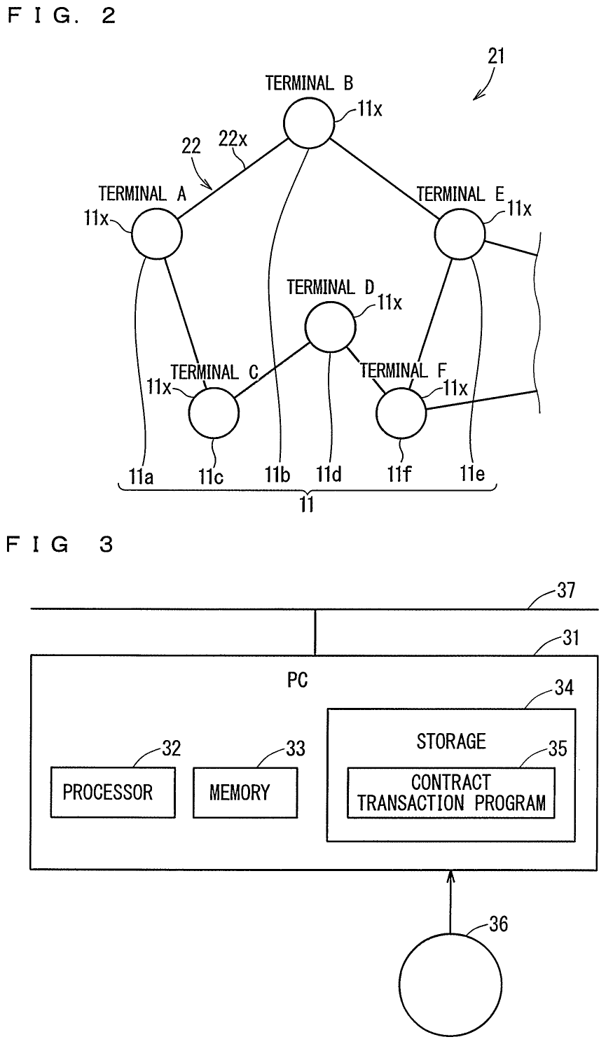

FIG. 2 is a network diagram schematically illustrating a P2P network configured by a plurality of terminals included in the contract transaction system according to Embodiment 1.

A P2P network 21 in FIG. 2 includes the plurality of terminals 11. FIG. 2 illustrates only terminals 11a, 11b, 11c, 11d, 11 e, and 11f among the plurality of terminals 11.

As illustrated in FIG. 2, the P2P network 21 includes a plurality of communication lines 22. Each communication line 22x included in the plurality of communication lines 22 communicatively connects two terminals included in the plurality of terminals 11.

Each of the terminals 11x knows an address of a terminal communicatively connected to the terminal 11x, can transmit data to the terminal, and can receive data from the terminal.

Each of the terminals 11x is operated by one user who owns the terminal 11x. Thus, the terminals 11a, 11b, 11c, 11d, 11e, 11f, . . . are operated by users A, B, C, D, E, F, . . . , respectively. Each of the terminals 11x may be operated by two or more users who share the terminal 11x.

1.4 Hardware Configuration of Each Terminal

FIG. 3 is a block diagram schematically illustrating a hardware configuration of each terminal included in the contract transaction system according to Embodiment 1.

Each of the terminals 11x includes a personal computer (PC) 31 illustrated in FIG. 3. Each of the terminals 11x may include information processing equipment other than the PC 31. Each of the terminals 11x may be, for example, a smart phone or a tablet.

As illustrated in FIG. 3, the PC 31 includes a processor 32, a memory 33, and a storage 34.

A contract transaction program 35 is installed in the storage 34. The contract transaction program 35 may be installed by writing, into the storage 34, the contract transaction program 35 read from an external recording medium 36 or received through a network 37.

Examples of the processor 32 include a central processing unit (CPU), a graphics processing unit (GPU), and a digital signal processor (DSP). Examples of the memory 33 include a random access memory (RAM). Examples of the storage 34 include a hard disk drive, a solid state drive, and a RAM disk. Examples of the external recording medium 36 include a compact disk (CD), a Digital Versatile Disc (DVD), a Blu-ray disc (BD), and a Universal Serial Bus (USB) memory.

The memory 33, the storage 34, and the external recording medium 36 are non-transitory computer-readable recording media in which the contract transaction program 35 is recorded.

In the PC 31, the contract transaction program 35 installed in the storage 34 is loaded into the memory 33. Then, the processor 32 executes the loaded contract transaction program 35. Thereby, the PC 31 operates as each of the terminals 11x.

1.5 Elements Included in Each Terminal

As illustrated in FIG. 1, each of the terminals 11x includes an authentication information obtaining unit 41, a bid data obtaining unit 42, a bid data transmitter 43, a contract result calculator 44, a contract result transmitter 45, a contract result receiver 46, a contract result examining unit 47, a contract result selector 48, a block receiver 49, a block selector 50, and a contract result storage 51. The bid data obtaining unit 42 includes a bid data receiver 54 and a bid data generator 55.

These elements are configured by loading, into the memory 33, the contract transaction program 35 installed in the storage 34 and executing the loaded contract transaction program 35 by the processor 32. A part of these elements may be configured by hardware that does not execute the program.

1.6 Procedure to be Performed by Each Terminal

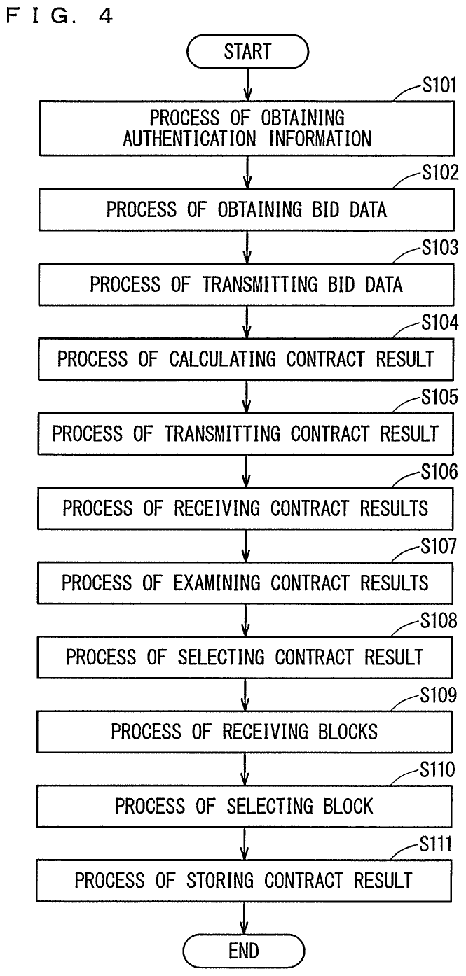

FIG. 4 is a flowchart illustrating a procedure to be performed by each terminal included in the contract transaction system according to Embodiment 1.

Each of the terminals 11x executes Steps S101 to S111 in FIG. 4.

In Step S101, the authentication information obtaining unit 41 performs a process of obtaining authentication information. Here, the authentication information obtaining unit 41 obtains the digital certificate 104 of each of the terminals 11x from the Certificate Authority 12, and stores the obtained digital certificates 104 of the terminals 11x. The digital certificate 104 to be obtained is, for example, a digital certificate that conforms to the X.509 standard that is a public key infrastructure and is defined by the International Telecommunication Union Telecommunication Standardization Sector (ITU-T).

Next in Step S102, the bid data obtaining unit 42 performs a process of obtaining bid data. Here, the bid data obtaining unit 42 obtains the bid data 101, and stores the obtained bid data 101. Accordingly, the bid data obtaining unit 42 obtains the bid data set 103, and stores the obtained bid data set 103. Examples of the bid data 101 to be obtained include the bid data 101x received by the bid data receiver 54 from a terminal that is not included in the plurality of terminals 11, the bid data 101y received by the bid data receiver 54 from each of the other terminals 11y included in the plurality of terminals 11, and bid data that is generated by each of the terminals 11x using the bid data generator 55 and is not illustrated. Each of the terminals 11x generates the bid data through operating the terminal 11x by the user of the terminal 11x. The terminal that is not included in the plurality of terminals 11 is, for example, a terminal owned by the user. The terminal owned by the user is, for example, a smart phone owned by the user.

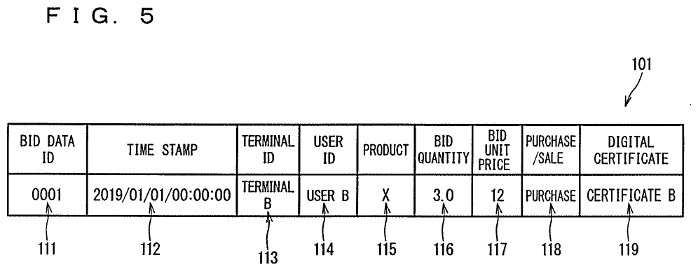

FIG. 5 illustrates example bid data to be obtained by each terminal included in the contract transaction system according to Embodiment 1.

As illustrated in FIG. 5, the bid data 101 to be obtained includes a bid data identifier (ID) 111, a time stamp 112, a terminal ID 113, a user ID 114, a product 115, a bid quantity 116, a bid unit price 117, purchase and sale classification 118, and a digital certificate 119.

The bid data ID 111, the time stamp 112, the terminal ID 113, the user ID 114, the product 115, the bid quantity 116, the bid unit price 117, the purchase and sale classification 118, and the digital certificate 119 are described in the first to ninth columns in the table.

The bid data ID 111 identifies the bid data 101. The bid data ID 111 is determined by avoiding an overlap with bid data IDs included in other pieces of bid data. The bid data ID 111 is, for example, a hash value to be returned when information on a terminal that has generated the bid data 101 or the time at which the bid data 101 has been generated is passed to a hash function as an argument.

The time stamp 112 indicates the time at which the bid data 101 has been generated. The time stamp 112 has a format “yyyy/MM/dd/hh:mm:ss”. “yyyy” indicates a year. “MM” indicates a month. “dd” indicates a date. “hh” indicates an hour. “mm” indicates a minute. “ss” indicates a second.

The terminal ID 113 identifies the terminal that has generated the bid data 101.

The user ID 114 identifies the user that has created the bid data 101.

The product 115, the bid quantity 116, the bid unit price 117, and the purchase and sale classification 118 indicate the product, the bid quantity, the bid unit price, and the classification between purchase and sale, respectively, as the details of the bid indicated by the bid data 101. The purchase and sale classification 118 indicates whether the bid data 101 is purchasing bid data or selling bid data. “PURCHASE” in the purchase and sale classification 118 indicates that the bid data 101 is purchasing bid data. “SALE” in the purchase and sale classification 118 indicates that the bid data 101 is selling bid data.

The digital certificate 119 is a digital certificate of the terminal that has generated the bid data 101.

When the user A has created, at 00:00:30 on Jan. 1, 2019, purchasing bid data describing details of a purchasing bid for showing an intention of purchasing a product “X” at a bid unit price “12” only in a bid quantity “2.0” using the terminal A, the bid data ID 111 is, for example, 0002. The time stamp 112 is “2019/01/01/00:00:30”. Furthermore, the terminal ID 113 is a terminal ID of the terminal A. Furthermore, the user ID 114 is a user ID of the user A. The product 115 is “X”. The bid quantity 116 is “2.0”. The bid unit price 117 is “12”. The purchase and sale classification 118 is “PURCHASE”. The digital certificate 119 is “DIGITAL CERTIFICATE A” that is a digital certificate of the terminal A.

Next in Step S103, the bid data transmitter 43 performs a process of transmitting bid data. Here, the bid data transmitter 43 transmits the obtained bid data 101 to the other terminals 11y. The bid data transmitter 43 broadcasts the obtained bid data 101 to the other terminals 11y.

Next in Step S104, the contract result calculator 44 performs a process of calculating a contract result. Here, the contract result calculator 44 calculates the contract result 102x from the obtained bid data set 103, and stores the calculated contract result 102x. When a deadline for the bid is set at intervals of 5 minutes, the contract result calculator 44 calculates the contract result 102x at intervals of 5 minutes. For example, when the current time is 00:05:00 on Jan. 1, 2019, the contract result calculator 44 calculates the contract result 102x from the bid data set 103 including the bid data 101 including the time stamp 112 indicating the time before 00:05:00 on Jan. 1, 2019. The contract result calculator 44 completes a contract transaction between a purchasing bid and a selling bid for each type of the product 115. A combination of a purchasing bid and a selling bid between which a contract transaction is completed, a contract quantity, and a contract price are determined, for example, similarly to the itayose method before opening the stock market.

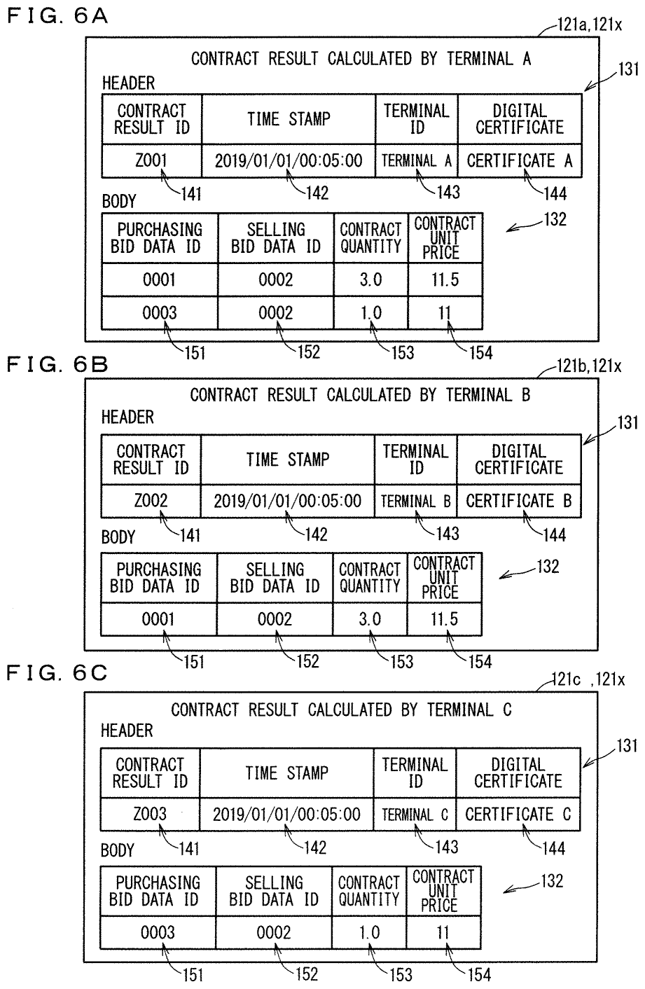

FIG. 6 illustrates example contract results calculated by terminals included in the contract transaction system according to Embodiment 1.

FIG. 6 (a), FIG. 6 (b), and FIG. 6 (c) illustrate examples of a contract result 121a calculated by the terminal 11a, a contract result 121b calculated by the terminal 11b, and a contract result 121c calculated by the terminal 11c, respectively.

As illustrated in FIG. 6, each of contract results 121x included in the contract results 121a, 121b, and 121c includes a header 131 and a body 132.

As illustrated in FIG. 6, the header 131 includes a contract result ID 141, a time stamp 142, a terminal ID 143, and a digital certificate 144.

The contract result ID 141, the time stamp 142, the terminal ID 143, and the digital certificate 144 are described in the first to fourth columns in the table.

The contract result ID 141 identifies each of the contract results 121x. The contract result ID 141 is determined by avoiding an overlap with contract results ID included in other contract results. The contract result 1D 141 is, for example, a hash value to be returned when information on the terminal that has calculated each of the contract results 121x or the time at which the contract result 121x has been calculated is passed to a hash function as an argument.

The time stamp 142 indicates the time at which each of the contract results 121x has been calculated. The time stamp 142 has a format “yyyy/MM/dd/hh:mm:ss”. “yyyy” indicates a year. “MM” indicates a month. “dd” indicates a date. “hh” indicates an hour. “mm” indicates a minute. “ss” indicates a second.

The terminal ID 143 identifies a terminal that has calculated each of the contract results 121x.

The digital certificate 144 is a digital certificate of the terminal that has calculated each of the contract results 121x.

As illustrated in FIG. 6, the body 132 includes a purchasing bid data ID 151, a selling bid data ID 152, a contract quantity 153, and a contract unit price 154.

The purchasing bid data ID 151, the selling bid data ID 152, the contract quantity 153, and the contract unit price 154 are described in the first to fourth columns in the table.

The purchasing bid data ID 151 and the selling bid data ID 152 identify purchasing bid data and selling bid data describing details of a purchasing bid and details of a selling bid, respectively. A contract transaction has been completed between the purchasing bid and the selling bid.

The contract quantity 153 and the contract unit price 154 indicate a contract quantity and a contract unit price, respectively, as details of the completed contract transaction.

In the body 132, the purchasing bid data ID 151 and the selling bid data ID 152 indicating details of the purchasing bid and details of the selling bid, respectively, are associated with each other. The contract transaction has been completed between the purchasing bid and the selling bid.

Not a server but each of the terminals 11x needs to calculate the contract result 102x to complete a contract transaction in the P2P network 21. However, when each of the terminals 11x calculates the contract result 102x, the plurality of the data sets 103 obtained by the plurality of terminals 11 are sometimes inconsistent because of a communication delay or an influence such as the topology of the P2P network 21. As a result, the plurality of contract results 102x calculated by the plurality of terminals 11 are sometimes inconsistent. For example, suppose a case where the bid data set 103 obtained by the terminal 11a includes pieces of the bid data 101 including the bid data IDs 111 such as “0001”, “0002”, and “0003”, the bid data set 103 obtained by the terminal 11b includes pieces of the bid data 101 including the bid data IDs 111 such as “0001” and “0002”, and the bid data set 103 obtained by the terminal 11c includes pieces of the bid data 101 including the bid data IDs 111 such as “0002” and “0003”. The contract result 121a calculated by the terminal 11a, the contract result 121b calculated by the terminal 11b, and the contract result 121c calculated by the terminal 11c are inconsistent as illustrated in FIG. 6. In Step S108 of a process of selecting a contract result, one of the contract results 121a, 121b, and 121c is selected as the final result.

Next in Step S105, the contract result transmitter 45 performs a process of transmitting a contract result. Here, the contract result transmitter 45 transmits the calculated contract result 102x to the other terminals 11y. In the presence of other contract results 102y received by the contract result receiver 46 from the other terminals 11y, the contract result transmitter 45 transmits the received other contract results 102y to the other terminals 11y. The contract result transmitter 45 broadcasts the calculated contract result 102x and the received other contract results 102y to the other terminals 11y.

Next in Step S106, the contract result receiver 46 performs a process of receiving contract results. Here, the contract result receiver 46 receives, from the other terminals 11y, the other contract results 102y calculated by the other terminals 11y, and stores the received other contract results 102y.

Next in Step S107, the contract result examining unit 47 performs a process of examining contract results. Here, the contract result examining unit 47 examines the received other contract results 102y, and determines whether the other contract results 102y are candidates for one contract result to be selected in Step S108, based on a result of the examination. When determining the received other contract results 102y not as the candidates for one contract result to be selected, the contract result examining unit 47 deletes the other contract results 102y.

When examining the received other contract results 102y, the contract result examining unit 47 examines whether the other contract results 102y have consistency. When the received other contract results 102y have consistency, the contract result examining unit 47 determines the other contract results 102y as the candidates for one contract result to be selected. When the received other contract results 102y do not have consistency, the contract result examining unit 47 determines the other contract results 102y not as the candidates for one contract result to be selected, and deletes the other contract results 102y.

Examining whether the other contract results 102y have consistency includes, for example, the following examinations:

(1) examining whether the digital certificates 119 included in pieces of the bid data 101 identified by the purchasing bid data ID 151 and the selling bid data ID 152 included in the other contract results 102y are identical to the digital certificate 104 obtained from the Certificate Authority 12;

(2) examining whether the digital certificates 144 included in the other contract results 102y are identical to the digital certificate 104 obtained from the Certificate Authority 12;

(3) examining whether each of the times indicated by the time stamps 112 included in the pieces of bid data 101 identified by the purchasing bid data ID 151 and the selling bid data ID 152 included in the other contract results 102y is before the time indicated by the time stamp 142 included in the other contract results 102y;

(4) examining whether the bid unit price 117 included in the (purchasing) bid data 101 identified by the purchasing bid data ID 151 included in the other contract results 102y is lower than or equal to the bid unit price 117 included in the (selling) bid data 101 identified by the selling bid data ID 152 associated with the purchasing bid data ID 151;

(5) examining whether the bid unit price 117 included in the (selling) bid data 101 identified by the selling bid data ID 152 included in the other contract results 102y is higher than or equal to the bid unit price 117 included in the (purchasing) bid data 101 identified by the purchasing bid data ID 151 associated with the selling bid data ID 152;

(6) examining whether a sum of the bid quantities 116 included in pieces of the (purchasing) bid data 101 identified by pieces of the purchasing bid data ID 151 included in the other contract results 102y is lower than or equal to the bid quantity 116 included in the (selling) bid data 101 identified by the selling bid data ID 152 associated with the purchasing bid data ID 151; and

(7) examining whether a sum of the bid quantities 116 included in pieces of the (selling) bid data 101 identified by pieces of the selling bid data ID 152 included in the other contract results 102y is lower than or equal to the bid quantity 116 included in the (purchasing) bid data 101 identified by the purchasing bid data ID 151 associated with the selling bid data ID 152.

Next in Step S108, the contract result selector 48 performs a process of selecting a contract result. Here, the contract result selector 48 selects one contract result from among the calculated contract result 102x and the received other contract results 102y. When whether the other contract results 102y are the candidates for one contract result to be selected is determined, the contract result selector 48 selects one contract result from among the contract result 102x and the other contract results 102y determined as the candidates. When a deadline for the bid is set at intervals of 5 minutes, the contract result selector 48 selects one contract result at intervals of 5 minutes, and selects one contract result from among the contract result 102x calculated in the past 5 minutes and the other contract results 102y. The contract result selector 48 selects one contract result based on a selection criterion 107.

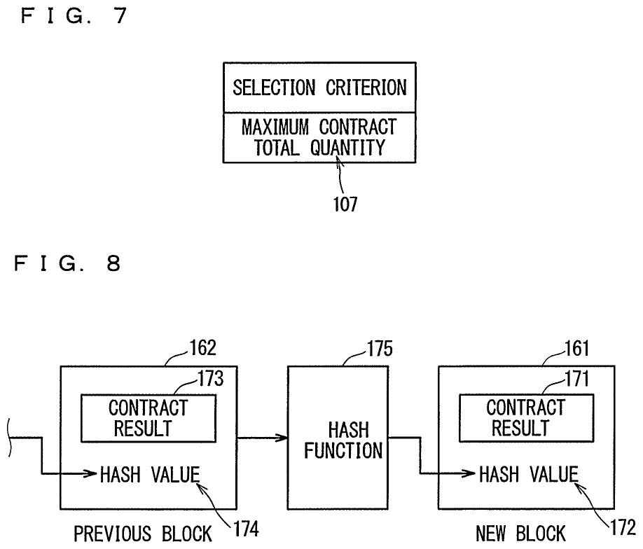

FIG. 7 illustrates an example selection criterion to be referred to by each terminal included in the contract transaction system according to Embodiment 1.

The selection criterion 107 in FIG. 7 is a selection criterion “MAXIMUM CONTRACT TOTAL QUANTITY”. When the selection criterion 107 is the selection criterion “MAXIMUM CONTRACT TOTAL QUANTITY”, a contract result whose sum of the contract quantities 153 included in the calculated contract result 102x and the received other contract results 102y is the maximum is the one contract result to be selected. For example, suppose a case where a deadline for the bid is set at intervals of 5 minutes, the current time is 00:10:00 on Jan. 1, 2019, and one contract result is selected from among the contract result 121a illustrated in FIG. 6 (a), the contract result 121b illustrated in FIG. 6 (b), and the contract result 121c illustrated in FIG. 6 (c) all of which have been calculated at 00:05:00 on Jan. 1, 2019. Here, the sum of the contract quantities 153 included in the contract result 121a is 3.0+1.0=4.0. The sum of the contract quantities 153 included in the contract result 121b is 3.0. The sum of the contract quantities 153 included in the contract result 121c is 1.0. Thus, the contract result 121a whose sum of the contract quantities 153 is a maximum of 4.0 is selected as one contract result. Even when the plurality of contract results 102x calculated by the plurality of terminals 11 are inconsistent, one reliable contract result is identifiable.

Next in Step S109, the block receiver 49 performs a process of receiving blocks. Here, the block receiver 49 receives previous (past) blocks 108 including one previous contract result selected before the one contract result is selected in Step S108, from the other terminals 11y. The block receiver 49 receives the previous blocks 108 from the other terminals 11y when each of the terminals 11x does not store the previous block 108. For example, when a deadline for the bid is set at intervals of 5 minutes, the terminal 11a does not store a previous block including one contract result selected at 00:00:00 on Jan. 1, 2019 by reason of a failure in the terminal 11a, and the terminal 11a has been recovered at 00:05:00 on Jan. 1, 2019, the block receiver 49 included in the terminal 11a receives the previous blocks from the other terminals 11y.

Next in Step S110, the block selector 50 performs a process of selecting a block. Here, the block selector 50 selects the previous block 108 to be followed by a new block, from among a plurality of the previous blocks received by the block receiver 49, and stores the selected previous block 108. The previous block 108 to be selected is one of a majority of previous blocks determined, based on majority rule, from among the plurality of previous blocks received by the block receiver 49.

Next in Step S111, the contract result storage 51 performs a process of storing a contract result. Here, the contract result storage 51 stores the selected one contract result, and updates the bid data 101. The updated bid data 101 is bid data obtained by replacing the bid quantity included in the bid data 101 before the update by a new bid quantity obtained by subtracting a contract quantity from the bid quantity. When storing the selected one contract result, the contract result storage 51 stores the new block including the selected one contract result. The new block to be stored follows the selected previous block 108.

FIG. 8 illustrates example blocks to be stored by each terminal included in the contract transaction system according to Embodiment 1.

As illustrated in FIG. 8, a new block 161 follows a previous block 162.

The new block 161 includes one contract result 171 selected, and a hash value 172. The previous block 162 includes one contract result 173 selected five minutes ago, and a hash value 174. The hash value 174 is a hash value to be returned when a block before last that is not illustrated is passed to a hash function 175 as an argument. The hash value 172 is a hash value to be returned when the previous block 162 is passed to the hash function 175 as an argument.

1.7 Advantages of Embodiment 1

Embodiment 1 enables completion of a contract transaction not in a server adopted in the client-server model but in the P2P network 21 including the plurality of terminals 11. This can provide the contract transaction system 1 having no single point of failure. Thus, the one contract result 171 that is reliable is identifiable from a plurality of inconsistent contract results.

### 2. Embodiment 2

### 2.1 Differences Between Embodiment 1 and Embodiment 2

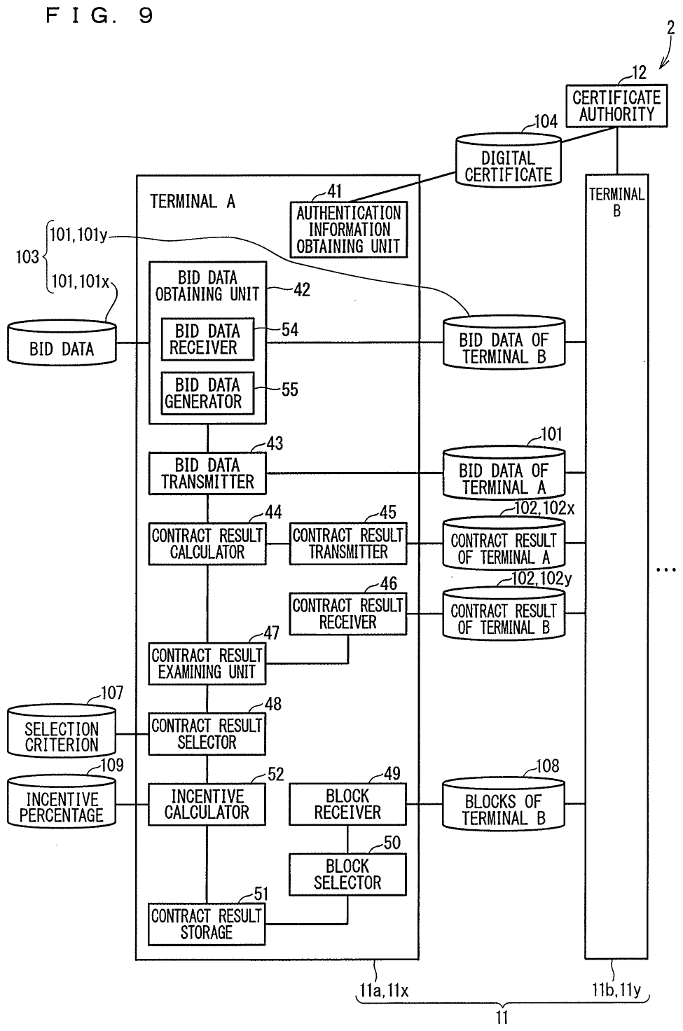

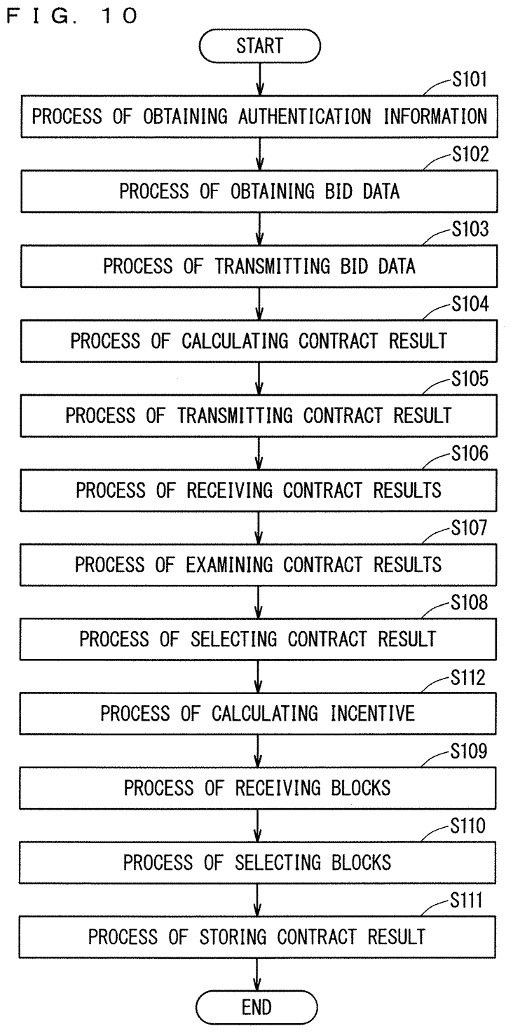

FIG. 9 is a block diagram schematically illustrating a contract transaction system according to Embodiment 2. FIG. 10 is a flowchart illustrating a procedure to be performed by each terminal included in the contract transaction system according to Embodiment 2.

A contract transaction system 2 according to Embodiment 2 in FIG. 9 mainly differs from the contract transaction system 1 according to Embodiment 1 in FIG. 1 in the following points. With respect to the points that are not described below, the same configurations as those of the contract transaction system 1 are applied to the contract transaction system 2.

As illustrated in FIG. 9, each of the terminals 11x included in the contract transaction system 2 further includes an incentive calculator 52. As illustrated in FIG. 10, each of the terminals 11x included in the contract transaction system 2 further executes Step S112.

In Step S112, the incentive calculator 52 performs a process of calculating an incentive. Here, the incentive calculator 52 calculates an incentive for a terminal that has calculated the selected one contract result. The user of the terminal can obtain the calculated incentive. The incentive calculator 52 calculates an incentive based on an incentive percentage 109.

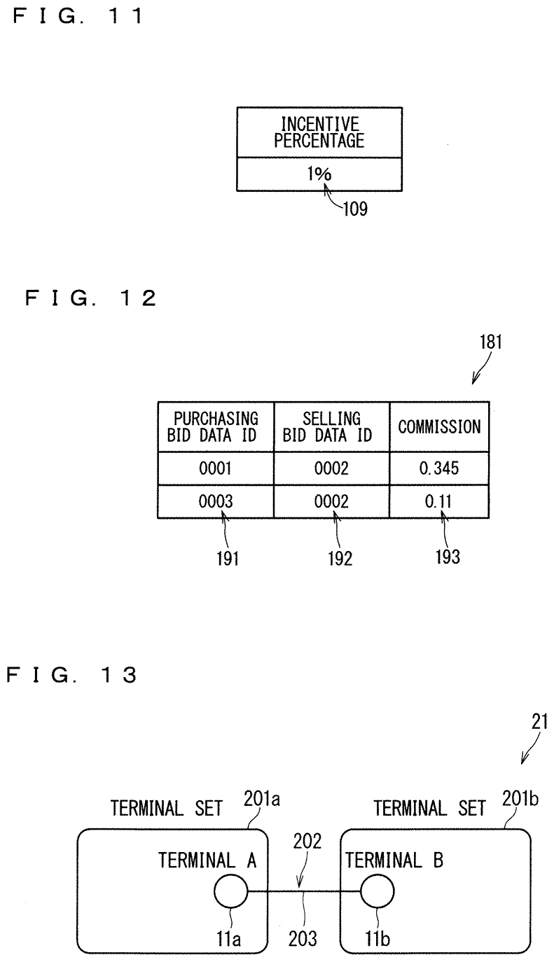

FIG. 11 illustrates an example incentive percentage to be referred to by each terminal included in the contract transaction system according to Embodiment 2. FIG. 12 illustrates an example incentive to be calculated by each terminal included in the contract transaction system according to Embodiment 2.

The incentive percentage 109 in FIG. 11 is an incentive percentage “1%”. When the incentive percentage 109 is the incentive percentage “1%” and one contract result to be selected is the contract result 121a in FIG. 6 (a), an incentive 181 in FIG. 12 is calculated.

The incentive 181 in FIG. 12 includes a purchasing bid data ID 191, a selling bid data ID 192, and a commission 193. The purchasing bid data ID 191, the selling bid data ID 192, and the commission 193 are described in the first to third columns in the table. The purchasing bid data ID 191 and the selling bid data ID 192 identify purchasing bid data and selling bid data describing details of a purchasing bid and details of a selling bid, respectively. A contract transaction has been completed between the purchasing bid and the selling bid. The commission 193 indicates a commission to be paid to the user of the terminal that has calculated the contract result indicating a result of the completed contract transaction. The commission 193 is a product of the contract quantity 153 included in the contract result indicating the result of the completed contract transaction, the contract unit price 154 included in the contract result, and the incentive percentage 109. Thus, the commission 193 to be paid to the user A of the terminal 11a that has calculated the contract result 121a indicating a result of the contract transaction completed between a purchasing bid with details indicated by the purchasing bid data identified by the purchasing bid data ID 191 of “0001” and a selling bid with details indicated by the selling bid data identified by the selling bid data ID 192 of “0002” is 3.0×11.5×1%=0.345. A purchasing user B who has created the purchasing bid data identified by the purchasing bid data ID 191 of “0001” pays the commission 193 of “0.345” to the user A of the terminal 11a with the digital certificate 144 of “DIGITAL CERTIFICATE A”. Furthermore, the commission 193 to be paid to the user A of the terminal 11a that has calculated the contract result 121a indicating a result of the contract transaction completed between a purchasing bid with details indicated by the purchasing bid data identified by the purchasing bid data ID 191 of “0003” and a selling bid with details indicated by the selling bid data identified by the selling bid data ID 192 of “0002” is 1.0×11×1%=0.11. A purchasing user C who has created the purchasing bid data identified by the purchasing bid data ID 191 of “0003” pays the commission 193 of “0.11” to the user A of the terminal 11a with the digital certificate of “DIGITAL CERTIFICATE A”. The purchasing user and the selling user may divide the commission 193 fifty-fifty to pay the commission 193. The purchasing user may pay the commission 193.

In Step S111, the contract result storage 51 performs a process of storing a contract result. Here, the contract result storage 51 stores the incentive 181 calculated together with the selected one contract result, and updates the bid data 101.

2.2 Advantages of Embodiment 2

Embodiment 2 produces the same advantages as Embodiment 1.

In addition, Embodiment 2 produces the following advantages.

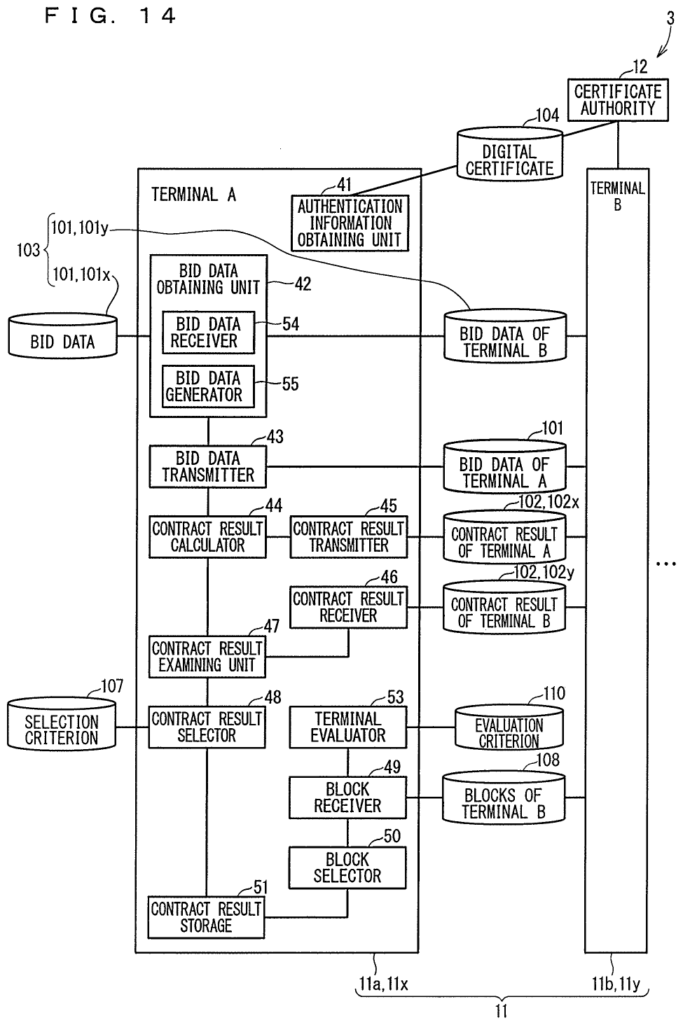

FIG. 13 schematically illustrates an example topology of a P2P network.

When the P2P network 21 has the topology illustrated in FIG. 13, a communication line 202 that communicatively connects a terminal set 201a including the terminal 11a to a terminal set 201b including the terminal 11b is solely a communication line 203 that communicatively connects the terminal 11a to the terminal 11b. Thus, when the communication via the communication line 203 is lost, the P2P network 21 is partitioned, and the contract result calculated in the terminal set 201a is different from the contract result calculated in the terminal set 201b.

Embodiment 2 enables the user of a terminal that has calculated the one contract result to be selected, that is, a contract result whose sum of the contract quantities 153 is the maximum to obtain the incentive 181. Thus, there are motivations to increase the number of pieces of the bid data 101 to be received by each of the terminals 11x and to be reflected on the contract result 102x calculated by the terminal 11x so that the user obtains the incentive 181. Here, increase in the number of terminals to be communicatively connected to each of the terminals 11x is effective at increasing the number of pieces of the bid data 101 to be received by the terminal 11x. Thus, there is a motivation to increase the number of the communication lines 22 that are the plurality of communication lines 22. This consequently can prevent partitioning the P2P network 21, and prevent the contract result calculated in the terminal set 201a from differing from the contract result calculated in the terminal set 201b.

### 3. Embodiment 3

### 3.1 Differences Between Embodiment 1 and Embodiment 3

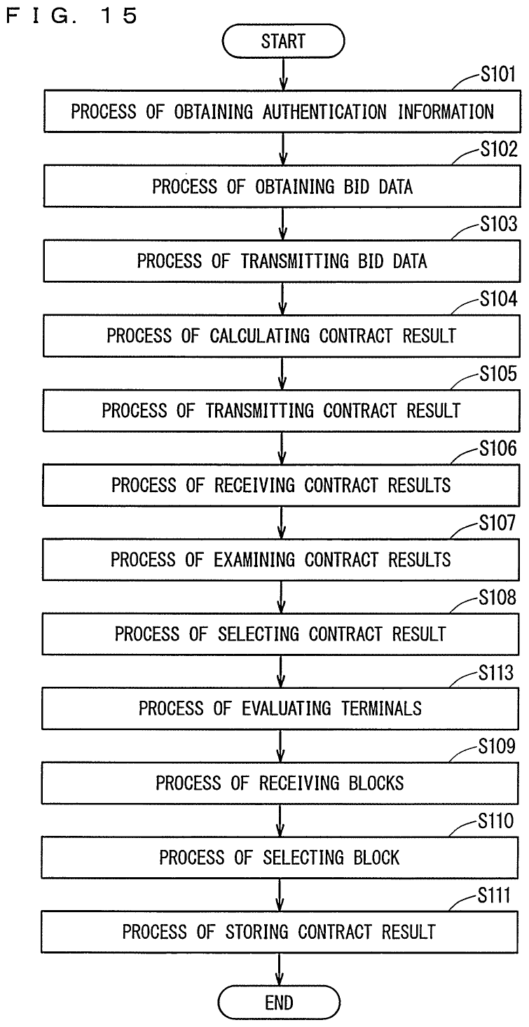

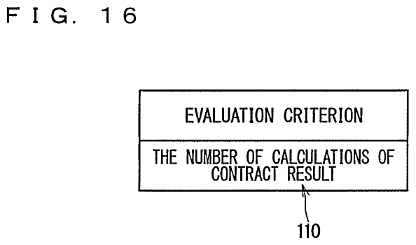

FIG. 14 is a block diagram schematically illustrating a contract transaction system according to Embodiment 3. FIG. 15 is a flowchart illustrating a procedure to be performed by each terminal included in the contract transaction system according to Embodiment 3.

A contract transaction system 3 according to Embodiment 3 in FIG. 14 mainly differs from the contract transaction system 1 according to Embodiment 1 in FIG. 1 in the following points. With respect to the points that are not described below, the same configurations as those of the contract transaction system 1 are applied to the contract transaction system 3.

As illustrated in FIG. 14, each of the terminals 11x included in the contract transaction system 3 further includes a terminal evaluator 53. As illustrated in FIG. 15, each of the terminals 11x included in the contract transaction system 3 further executes Step S113.

In Step S113, the terminal evaluator 53 performs a process of evaluating terminals. Here, the terminal evaluator 53 evaluates the other terminals 11y, and selects a terminal from which the previous block 108 has been transmitted, from the other terminals 11y based on a result of the evaluation. The terminal evaluator 53 evaluates the other terminals 11y based on an evaluation criterion 110.

FIG. 16 illustrates an example evaluation criterion to be referred to by each terminal included in the contract transaction system according to Embodiment 3.

The evaluation criterion 110 in FIG. 16 is an evaluation criterion “THE NUMBER OF CALCULATIONS OF CONTRACT RESULT”. When the evaluation criterion 110 is the evaluation criterion “THE NUMBER OF CALCULATIONS OF CONTRACT RESULT”, the terminal evaluator 53 retrieves the other terminals 11y that have calculated the contract results, with reference to the previous blocks already received. The terminal evaluator 53 sorts the other terminals 11y in descending order based on the number of calculations of a contract result, and selects a pre-set number of the other terminals 11y that are ranked higher as the terminal from which the previous block 108 has been transmitted.

Next in Step S109, the block receiver 49 performs a process of receiving blocks. Here, the block receiver 49 receives the previous block 108 from the selected terminal from which the previous block 108 has been transmitted.

3.2 Advantages of Embodiment 3

Embodiment 3 produces the same advantages as Embodiment 1.

In addition, Embodiment 3 produces the following advantages.

In Embodiment 1, the block receiver 49 receives a plurality of previous blocks from the plurality of other terminals 11y when each of the terminals 11x does not store the previous block 108. Furthermore, the block selector 50 selects the previous block 108 to be followed by a new block, from among the received plurality of previous blocks. The previous block 108 to be selected is determined from among the received plurality of previous blocks based on majority rule. However, the block receiver 49 needs to receive many previous blocks so that a result of the majority rule is reliable. Thus, each of the terminals 11x becomes burdensome in performing the process of receiving blocks.

In contrast, when each of the terminals 11x does not store the previous block, the previous block 108 is received from the selected terminal from which the previous block 108 has been transmitted in Embodiment 3. Thus, the block receiver 49 need not receive many previous blocks. Thus, each of the terminals 11x is less burdensome in performing the process of receiving blocks.

Embodiments can be freely combined, and each of Embodiments can be appropriately modified or omitted.

Although Embodiments are described in detail, the foregoing description is in all aspects illustrative, and does not restrict Embodiments. Therefore, numerous modifications and variations that have not yet been exemplified are devised.

### EXPLANATION OF REFERENCE SIGNS

1, 2, 3 contract transaction system, 11 plurality of terminals, 12 Certificate Authority, 21 P2P network, 41 authentication information obtaining unit, 42 bid data obtaining unit, 43 bid data transmitter, 44 contract result calculator, 45 contract result transmitter, 46 contract result receiver, 47 contract result examining unit, 48 contract result selector, 49 block receiver, 50 block selector, 51 contract result storage, 52 incentive calculator, 53 terminal evaluator.

1. A peer-to-peer terminal, comprising:
a bid data obtaining circuitry to obtain bid data;
a bid data transmitter to transmit the bid data to another peer-to-peer terminal;
a contract result calculator to calculate a contract result from a bid data set obtained by the bid data obtaining circuitry, the bid data set including the bid data;
a contract result transmitter to transmit the contract result to the other peer-to-peer terminal;
a contract result receiver to receive, from the other peer-to-peer terminal, another contract result calculated by the other peer-to-peer terminal; and
a contract result selector to select one contract result from among the contract result and the other contract result wherein
the contract result selector selects the one contract result based on a selection criterion when the contract result is different from the other contract result.

2. The peer-to-peer terminal according to claim 1,
wherein the selection criterion is that the contract result selector selects the one contract result whose sum of at least one contract quantity is maximum.

3. The peer-to-peer terminal according to claim 1, further comprising
an incentive calculator to calculate an incentive for a peer-to-peer terminal that has calculated the one contract result.

4. The peer-to-peer terminal according to claim 1, further comprising:
a block receiver to receive, from the other peer-to-peer terminal, a previous block including one previous contract result selected before the contract result selector selects the one contract result; and
a contract result storage to store a new block following the previous block and including the one contract result.

5. The peer-to-peer terminal according to claim 4,
wherein the peer-to-peer terminal includes a plurality of other peer-to-peer terminals, and the block receiver receives a plurality of previous blocks,
the peer-to-peer terminal, further comprising
a block selector to select the previous block from among the plurality of previous blocks.

6. The peer-to-peer terminal according to claim 4, the peer-to-peer terminal including a plurality of other peer-to-peer terminals, the peer-to-peer terminal further comprising
a terminal evaluator to evaluate the plurality of other peer-to-peer terminals, and select a peer-to-peer terminal from which the previous block has been transmitted, from among the plurality of other peer-to-peer terminals based on a result of the evaluation,
wherein the block receiver receives the previous block from the peer-to-peer terminal from which the previous block has been transmitted.

7. The peer-to-peer terminal according to claim 1, further comprising
a contract result examining circuitry to examine the other contract result, and determine whether the other contract result is a candidate for the one contract result, based on a result of the examination,
wherein the contract result selector selects the one contract result from among the contract result and the other contract result that is determined as the candidate for the one contract result.

8. The peer-to-peer terminal according to claim 1, further comprising
an authentication information obtaining circuitry to obtain a first-type digital certificate of the peer-to-peer terminal from a Certificate Authority,
wherein the bid data includes a second-type digital certificate of a peer-to-peer terminal that has generated the bid data, and
the contract result includes a third-type digital certificate of the peer-to-peer terminal that has calculated the contract result.

9. A contract transaction system, comprising
a plurality of peer-to-peer terminals,
wherein each of the plurality of peer-to-peer terminals is the peer-to-peer terminal according to claim 1.
